(19) United States
(12) Patent Application Publication
(10) Pub. No.: US 2010/0025512 A1
(43) Pub. Date: Feb. 4, 2010

(54) MULTIMATERIAL WEAR PART OF A VERTICAL SHAFT IMPACTOR

(75) Inventors: Jari Liimatainen, Tampere (FI); Päivi Kivikytö-Reponen, Tampere (FI)

Correspondence Address: BUCHANAN, INGERSOLL & ROONEY PC, POST OFFICE BOX 1404, ALEXANDRIA, VA, 22313-1404, US

(73) Assignee: METSO MINERALS, INC., HELSINKI (FI)

(21) Appl. No.: 12/522,333

(22) PCT Filed: Dec. 12, 2007
(86) PCT No.: PCT/FI07/50681

§ 371 Date: Sep. 2, 2009

(30) Foreign Application Priority Data
Jan. 17, 2007 (FI) 20070040

(51) Int. Cl. B02C 1/10

(52) U.S. Cl. 241/300; 241/291

(57) ABSTRACT

A wear part of a vertical shaft impactor consisting of at least two or a plurality of materials, whereby the wear part comprises a base part composed of a polymer material, having wear resistant inserts attached to the base part.

The present invention relates to a wear part of a vertical shaft impactor, said wear part consisting of at least two or a plurality of materials, at least one of said materials being a polymer based material, such as an elastomer based material. Wear resistant inserts consisting of one or a plurality of wear resistant materials are vulcanized into this kind of a polymer based material. Further, the wear part may comprise, when necessary, supporting structures or connecting structures used, for example, for connecting the wear part to the other parts of the impactor.

### BACKGROUND

The vertical shaft impactor (VSI) is an impact crusher. A vertical shaft impactor is commonly used for crushing rocks or other minerals, or it can also be used in various recycling processes. Typical of the vertical shaft impactor is that the minerals crushed in it have an advantageous shape with regard to the further processes and use.

The wear of the wear part components of the vertical shaft impactor has a significant financial influence. Efforts are continuously made to improve the wear resistance and efficiency of the components. Elements of the vertical shaft impactors such as rotor shoes and other components being exposed to a high flow rate of the material fed into the crusher, in other words the feed material, constitute a significant cost factor throughout the life span of the vertical shaft impactor. Further, improving the wear resistance yields benefits with regard to both the productivity and the quality of the process, and the life span of the materials of the components and their environmental load.

Efforts have been made to extend the useful life of the wear parts both by altering the process conditions and also by further developing the wear part itself. The wear resistance of a component can be altered substantially by altering the geometry, structure and materials of the wear parts. In the mineral industry, the wear of materials is caused by the motion of streams of minerals or mineral particles relative to the wear surface, resulting in erosion of the wear surface. In these conditions the wear of the material is said to be abrasive, but the fatigue of the component surfaces may also be of significance in these applications, if the abrasive wear resistance can be adequately improved. In general, the mechanisms of the abrasive wear can be divided into formation of the surface by plastic deformation resulting in loss of surface material, and into mechanisms based on brittle failure, such as the peeling off of the deformed surface portions by breaking, or the breaking of the material without deformation.

Particularly, since multimaterial combinations form physical obstacles to the abrasive particle streams, and since different combinations of materials wear simultaneously by different mechanisms of wear, they are effective in reducing the wear of the material, which is of advantage to the whole wear part component. The use of the multimaterials can provide much higher local surface hardness values and, simultaneously, improved local toughness in a component, both of which are properties needed in the most practical implementations of the crusher components. A component of a single material group, e.g. cast iron, can not meet these requirements. Components of a single material group are often modified by chemical composition and by manufacturing processes, and by additional treatments like for example heat treatment. The aim is to affect the microstructure, within certain limit values.

As is known, components of both a single material group (ferrous materials) or cermet multimaterial components are used in the wear parts of vertical shaft impactors. In cermet components, the properties of a metal are combined with the wear resistance of ceramics. The ceramics have typically high strength and hardness, but low toughness. A critical factor in such components consisting of cermet materials is the selection of a metallic material with sufficient toughness in order to avoid disastrous fractures of components.

In general, the multimaterial components are more challenging than the single-material components both in terms of the manufacturing techniques and the design. In particular, the strength values of the boundary surfaces between the various materials must be sufficiently high in order to avoid the damaging and the increased wear of the components. The various material groups of the component must have a positive synergy effect on the wear.

The designing and manufacturing of the multimaterial components is challenging in many ways. Achieving optimal performance of a component is the result of a long design and testing process that is carried out to find out the correct proportions of various material groups and geometries, to provide the best possible implementation in terms of the wear. Further, the different manufacturing techniques set requirements to the proportions of various materials and geometries. The strong and wear resistant component of ceramic, metal or cermet has to retard the wear and to form a suitable wear profile in the practical application, whereas the tough material has to provide the sufficient toughness properties for the structure.

A typical wear part component of a crusher, such as a crusher shoe, consists of an iron based metal, e.g. cast iron, with eventual added ceramic inserts. Multimaterial wear parts of the vertical shaft impactor, wherein, conventionally, wear resistant inserts are arranged on an iron based frame material, are disclosed in various patent publications, such as U.S. Pat. No. 6,171,713 B1, EP 1305116 B1, WO 03/011466 A1, and U.S. Pat. No. 6,601,789. Various insert geometries for a shoe of a vertical shaft impactor, wherein the frame is of an iron based alloy or cast iron and the inserts are ceramic, are described in U.S. Pat. No. 6,171,713 B1 and EP 1305116 B1. WO 03/011466 A1 focuses on geometric matters of the inserts of the wear parts of the vertical shaft impactor, an iron based base material and hard metal insert material being mentioned as typical materials. U.S. Pat. No. 6,601,789 focuses on the positioning of the inserts in the crusher shoe and is based on various known joining and machining methods. As mentioned in the publication, the base material may be one of a plurality of different alloys, such as cast iron, and the inserts may consist of several different types of ceramic materials.

Patent publications U.S. Pat. No. 3,607,606, WO2006132582, U.S. Pat. No. 48,486,181 disclose a multimaterial component for wear resistant lining applications employing a wear resistant insert, such as a ceramic insert, further having an elastomer as one component of the solution. Publications U.S. Pat. No. 3,607,606 and WO2006132582 disclose mainly plate type of linings. U.S. Pat. No. 3,607,606 is limited to aluminum oxide based ceramic inserts, WO2006132582 is very strictly limited to the insert geometry and the ceramic materials, and U.S. Pat. No. 48,486,181 is limited to a mill lining component.

### DESCRIPTION OF THE INVENTION

With the solution in accordance with the present invention, improved wear resistance and novel features for the wear part of the vertical shaft impactor, such as a crusher shoe, can be provided, by combining the wear resistant inserts made of metal, ceramic or cermet materials with a polymer to be vulcanized around the inserts. The most important benefit with regard to the wear of the wear part is the synergy benefit of the polymer and the insert materials, that is, the benefits gained for said wear parts of vertical shaft impactors, e.g. crusher shoes, by the combined effect of the materials. In terms of the wear, the polymer material functions as a tough component, and in addition it functions as a shock absorber and as a binding material for the wear pieces, i.e. inserts. The polymer material wears off faster than the inserts, that are arranged with respect to the abrasive stream of minerals so, that they provide a wear protection for the polymer based material.

In this context, the term insert refers to macroscopic wear resistant pieces arranged in the base material to provide predetermined wear properties.

A polymer-metallic, polymer-ceramic or polymer-metallic-ceramic multimaterial wear part of the vertical shaft impactor provides significant advantages over the prior art wear parts. For example, the vulcanized rubber or other cross-linked elastomers have a quite good tolerance for wear and are known by their elasticity/toughness. Further, they are firm, stiff and incompressible. Other advantageous features of such elastomers include vibration damping capacity and lightness compared to metallic materials and many ceramics. Because of these properties, multimaterial wear parts and components comprising at least one polymeric material can provide significant advantages.

One of the most important advantages of a multimaterial wear part consisting of at least two or a plurality of materials, at least one of said materials being polymer based, is the combined effect of the various materials, i.e. the synergy wherein the elasticity, toughness and “shock damping capacity” of the polymer is combined with a firm and wear resistant, but more fragile material. The most significant advantage with regard to the wear of the wear part component is, in particular, said synergy benefit of the different materials, i.e. the benefits gained by the combined effect of the polymer materials and the other materials for said wear parts of the vertical shaft impactors, such as crusher shoes. In addition to the wear prevention, other notable financial factors include the decreased weight of the components, as heavier materials are replaced with the elastomer based materials, and the vibration damping capacity of the elastomers for example in the vibration and noise control.

More precisely, the wear part of a vertical shaft impactor of the present invention is characterized by what is stated in the characterizing part of Claim 1.

The present invention will be described by way of example in more detail in the following, with reference to the enclosed drawings, wherein:

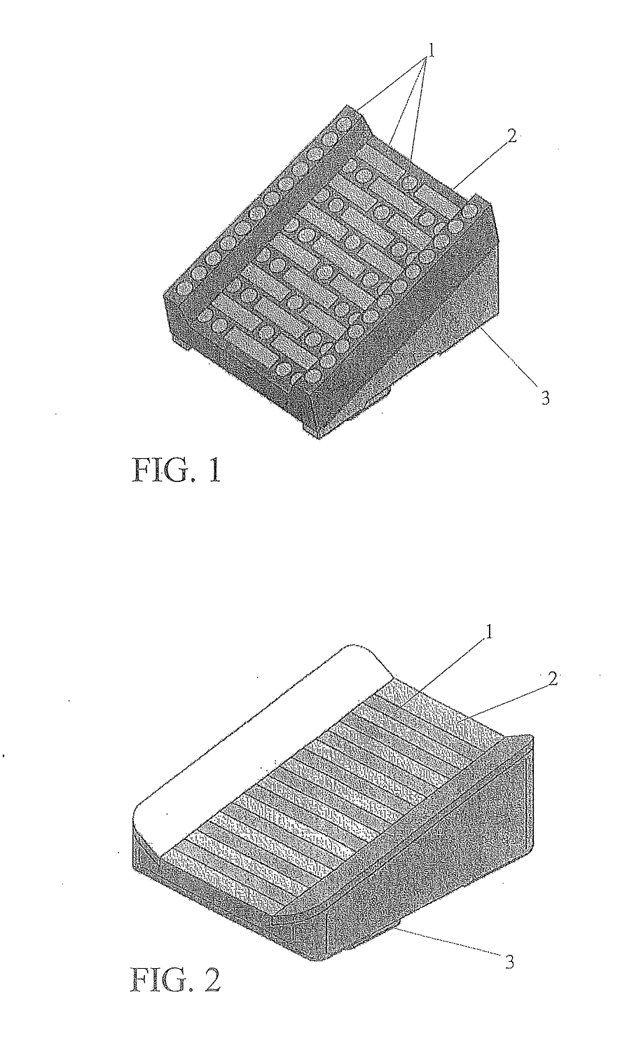

FIGS. 1-5 are schematic views showing the structures of some wear parts of the vertical shaft impactor in accordance with the present invention.

FIGS. 1 and 2 are schematic views of exemplary arrangements for wear resistant inserts in a shoe of a vertical shaft impactor. In these figures, inserts 1 are, in accordance with the invention, arranged in the base part 2 composed of an elastomer material, with the part 3 forming the support surface being provided under this combined component. The inserts 1 are arranged in principal in a transverse direction with respect to the abrasive mineral material stream, as is known in the art and a common practice in the wear prevention of a material. The form and the optimal mutual distance of the inserts 1 from each other depends on the wear conditions in the vertical shaft impactor (e.g., the size of the feed to the crusher is a factor in this connection), and will be tailored for each working-object based on the individual characteristics of the object. In addition to simple lines or patterns of circles and rectangles, the inserts 1 can form various patterns typically used and known as wear plates, such as fish bone, serrated and other patterns, commonly found in the nature, for example on the wear resistant shells and skins of different animals.

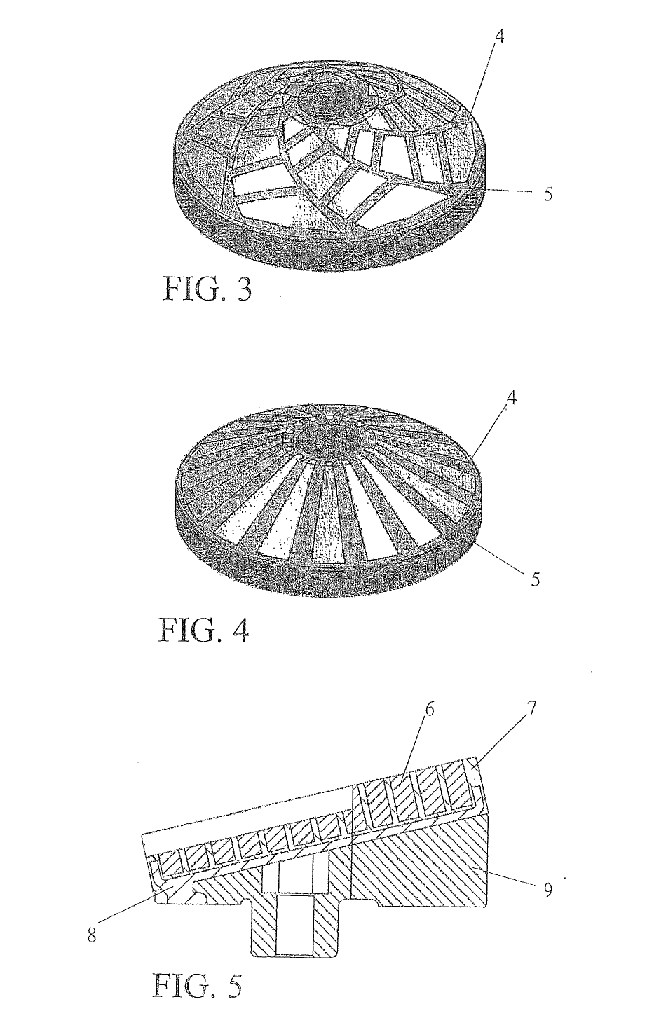

FIGS. 3 and 4 show another wear part of the vertical shaft impactor, more particularly in these figures a distributor plate, in which the solution according to the present invention is employed, wherein the surface that is exposed to the mineral stream is covered with wear resistant inserts 4, and a base part 5 consisting of an elastic polymer based material serves as a frame. Like in the examples of FIGS. 1 and 2, inserts 4 are typically arranged in transverse direction with respect to the mineral material stream. Like in FIGS. 1 and 2, the form and the mutual optimal distance of the inserts 4 from each other depends on the wear conditions, and will be tailored in accordance with the demands of each object. Similarly, the inserts 4 can form different patterns known as and typically used as wear protections.

The depth of the inserts shown in Figures from 1 to 4 can vary depending on the wear conditions in the vertical shaft impactor (like for example on the material to be crushed), that is, depending on the demand for wear protection, in other words the so called wear margin of the wear part. Similarly, the depth and length of the inserts may vary with respect to each other, because the demand for wear protection is different in different wear surfaces. The demand for wear protection depends on, for example, the velocity, amount and the angle of arrival and departure of the abrasives (the abrasive particles) to the surface, and thus a single surface may have even big local differences in the demand for wear protection. Principally, the wear conditions have a critical effect on the wear of the wear part components. In the case of a vertical shaft impactor, typical factors affecting the conditions include the rock, the mineral or the recycled product to be crushed, the particle size, velocity, trajectories and physical and chemical properties of the products, and the temperature and humidity of the environment.

In this connection, the term “material group of polymers” refers to an elastomer in general, such as raw rubber, isoprene, polybutadiene, butadiene, nitrile, ethylene, propylene, chloroprene or silicone rubber, or a mixture thereof. Typically, polymer based materials may contain filling or auxiliary materials and impurities, up to 30% by volume. The properties of a pure polymer or mixture are tried to be changed by using filling or auxiliary materials, like for example for improving the wear resistance of the material.

The inserts of the wear part component may consist of one or a plurality of the following materials, in various proportions: metal, ceramics or cermet. In this connection the term “metallic insert material” refers to ferrous materials, containing metallic carbides or oxides in a proportion of 10-40% by volume. The term “ceramic insert material” refers to either carbides or oxides of metallic elements, such as aluminum, titanium, tantalum, wolfram, chromium or zirconium or of a mixture thereof. A cermet insert material, which may be referred to as a composite material, a cermet or a hard metal, consists of carbides or oxides of metallic elements, such as aluminum, titanium, tantalum, wolfram, chromium, zirconium or a mixture thereof, and of a metallic binder, which is a pure metal or an alloy with cobalt, nickel or iron as the main component. The proportion of the binder in the composite material is max. 50% by volume. The proportion of the main component in the binder is more than 60% by volume.

FIG. 5 illustrates one of the wear part components of the vertical shaft impactor, the crusher shoe, implemented by means of a solution in accordance with the present invention, said crusher shoe comprising an insert cover 6 including the wear margin, a polymer based base part 7, and various fixing parts 8 and 9 for attaching the wear part component to the frame part of the vertical shaft impactor.

In the solution of the present invention, the mutual proportions of the materials and parts of the wear part depend on the wear conditions and the attachment of the wear part. The attaching parts may be vulcanized to the polymer based material, but alternatively, they may be joined together mechanically, whereby only a part of the components need to be changed during the maintenance. The most important property required of the attaching parts is the sufficient mechanical strength. By changing only the wear component part instead of the whole component, substantial benefits can be gained, both in terms of the costs and also of the environmental load.

1. A wear part of a vertical shaft impactor, said wear part consisting of at least two or a plurality of materials, wherein the wear part comprises a base part composed of a polymer material, and wear resistant inserts attached to said base part.

2. The wear part of claim 1, wherein the wear resistant inserts are attached to the base part by vulcanizing.

3. The wear part of claim 1, wherein the polymer material of the base part is of an elastomer material including filling or auxiliary materials and impurities max. 30% by volume.

4. The wear part of claim 1, wherein the inserts are metallic, ceramic or a cermet composite.

5. The wear part of claim 4, wherein the metallic inserts are of an iron based metal, including metallic carbides or oxides in a proportion of 10-40% by volume.

6. The wear part of claim 5, wherein the ceramic inserts consist of carbides or oxides of metallic elements of aluminum, titanium, tantalum, wolfram, chromium or zirconium or of mixtures thereof.

7. The wear part of claim 4, wherein the inserts are cermet inserts which are composites, cermets or hard metals, consist of carbides or oxides of metallic elements of aluminum, titanium, tantalum, wolfram, chromium or zirconium or a mixture thereof and of a metallic binder, and said binder being of a plain metal or a metal alloy and having cobalt, nickel or iron as the main component of the binder.

8. The wear part of claim 7, wherein the inserts consist of a composite material including the binder max. 50% by volume, and said binder including the main alloy at least 60% by volume.

9. The wear part of claim 1, wherein the wear resistant inserts are connected to the wear surface of the wear part according to the wear protection geometries known in the art.

10. The wear part of claim 1, wherein the wear part comprises supporting and attaching parts for supporting the wear part and for attaching it to the crusher.

11. The wear part of claim 2, wherein the polymer material of the base part is of an elastomer material including filling or auxiliary materials and impurities max. 30% by volume.

12. The wear part of claim 1, wherein said elastoner material is selected from the group consisting of raw rubber, isoprene, polybutadiene, butadiene, nitrile, ethylene, propylene, chloroprene or silicone rubber, and mixtures thereof.

13. The wear part of claim 2, wherein the inserts are metallic, ceramic or a cermet composite.

14. The wear part of claim 3, wherein the inserts are metallic, ceramic or a cermet composite.

15. The wear part of claim 5, wherein the inserts are cermet inserts which are composites, cermets or hard metals, consist of carbides or oxides of metallic elements of aluminum, titanium, tantalum, wolfram, chromium or zirconium or a mixture thereof and of a metallic binder, and said binder being of a plain metal or a metal alloy and having cobalt, nickel or iron as the main component of the binder.

16. The wear part of claim 6, wherein the inserts are cermet inserts which are composites, cermets or hard metals, consist of carbides or oxides of metallic elements of aluminum, titanium, tantalum, wolfram, chromium or zirconium or a mixture thereof and of a metallic binder, and said binder being of a plain metal or a metal alloy and having cobalt, nickel or iron as the main component of the binder.

17. The wear part of claim 2, wherein the wear resistant inserts are connected to the wear surface of the wear part according to the wear protection geometries known in the art.

18. The wear part of claim 3, wherein the wear resistant inserts are connected to the wear surface of the wear part according to the wear protection geometries known in the art.

19. The wear part of claim 2, wherein the wear part comprises supporting and attaching parts for supporting the wear part and for attaching it to the crusher.

20. The wear part of claim 3, wherein the wear part comprises supporting and attaching parts for supporting the wear part and for attaching it to the crusher.
